(19) United States
(12) Patent Application Publication
(10) Pub. No.: US 2003/0224669 A1
(43) Pub. Date: Dec. 4, 2003

(54) Method of improving cooking efficiency

(76) Inventors: James T.C. Yuan, Naperville, IL (US); John S. Novak, Naperville, IL (US); Edward F. Steiner, Downers Grove, IL (US); Vijay K. Juneja, North Wales, PA (US)

Correspondence Address: Air Liquide, Suite 1800, 2700 Post Oak Blvd., Houston, TX, 77056, US

(21) Appl. No.: 10/354,981

(22) Filed: Jan. 31, 2003

Related U.S. Application Data
(60) Provisional application No. 60/384,286, filed on May 30, 2002.

(51) Int. Cl. H01R 9/22

(52) U.S. Cl. 439/894

(57) ABSTRACT

A cooking process which demonstrates improved cooking efficiency of foodstuffs, improves the quality of such food and enhances the safety of food for consumption by mammals, especially humans. The process utilizes a treatment of foodstuff with an aqueous ozone solution combined with a cooking process to provide a synergistic effect on the killing rates of microorganisms as well as a reduction of the level of microorganisms on and in such foodstuffs. The method comprises sanitizing/disinfecting the foodstuff using an aqueous solution containing an effective amount of ozone, which comprises forming an aqueous solution of ozone, and contacting the foodstuff with the aqueous solution, and subsequently subjecting the foodstuff to a cooking process. The foodstuff is generally contacted with the aqueous solution for a time sufficient to substantially sanitize or disinfect the foodstuff. Optionally, the foodstuff may be packaged before or after the cooking process. The use of an aqueous ozone treatment process for foodstuffs, in conjunction with a cooking process provides a multi-technology approach to reducing the level of microorganisms associated with foodstuffs. The process therefore allows food processors to reduce the amount of cooking needed, i.e., temperature and/or time of cooking, with a resulting enhancement in food quality and safety.

### CROSS-REFERENCE TO RELATED APPLICATION(S)

This application is related to and claims priority under 35 U.S.C. §119(e) of U.S. Provisional Application Serial No. 60/384,286, filed May 30, 2002, the entire contents of which are incorporated herein by reference.

### STATEMENT REGARDING FEDERALLY SPONSORED RESEARCH OR DEVELOPMENT

This invention was made with United States government support provided by the United States Department of Agriculture (USDA) under CRIS No. 1935-42000-047 and MOU Agreement No. 58-1935-1M-114. The United States government has certain rights in this invention.

### BACKGROUND OF THE INVENTION

1. Field of the Invention

The present invention relates to processes for sanitizing a foodstuff, and particularly to sanitizing and improving the cooking efficiency of a foodstuff using a combination of ozone and heat treatment.

2. Brief Description of Art

The primary problem regarding food spoilage in public health is microbial growth. If pathogenic microorganisms are present, then growth of such microorganisms can potentially lead to food-bore outbreaks and significant economic losses. Since 1997, food safety concerns have increasingly been brought to the consumers' attention, and those concerns have become even stronger today. Recent outbreaks from Salmonella and E. coli 0157:H7 have increased the focus on food safety from a regulatory perspective, as well. A report issued from National Research Council (NRC) in 1988 indicated that there were approximately 9,000 human deaths a year from 81 million annual cases of food poisoning. A recent study completed by the Centers for Disease Control and Prevention (CDC) estimated that food-borne diseases cause approximately 76 million illnesses, 325,000 hospitalizations and 5,000 deaths annually in the U.S. Those numbers reveal the dramatic need for effective means of disinfecting food products in order to ensure food safety.

Currently, food manufacturers use different technologies, such as heating, to eliminate, retard, or prevent microbial growth. However, effective sanitation depends on the product/process type, and not all currently available technology can deliver an effective reduction of microorganisms. Instead, another level of health problems may be created or the quality of the treated food may deteriorate. For example, chlorine has been widely used as a sanitizer of choice since World War I. However, concerns regarding the safety of carcinogenic and toxic byproducts of chlorine, such as chloramines and trihalomethanes, have been raised in recent years. Another example is heat treatment. Even though heat is very efficient in killing bacteria, it also destroys some nutrients, flavors, or textural attributes of food and food products.

Ozone, an unstable, colorless gas with a distinct odor has been proven to work more effectively on spoilage microorganisms than a classic disinfectant such as chlorine. Due to its instability, the three oxygen molecules of ozone break apart to form one diatomic oxygen molecule and another free oxygen radical. This free oxygen radical attacks the cell wall and oxidizes it thus increasing the chance of permeability to the inner surfaces of the cell. This reaction of ozone on cell structures is irreversible; therefore the cells either become attenuated or die.

As is generally known, Ozone may be produced by subjecting oxygen to UV radiation having a wavelength below 200 nm or by corona discharge (which requires high electric energy).

Historically, ozone has been widely used for water treatment since the early 1900's. Some well-known applications include disinfection of swimming pools, spas, cooling towers, and sewage plants, or to disinfect water (e.g. municipal water or waste water treatment). For example, U.S. Pat. No. 4,256,574 describes an ozone system for applying ozone to waste water for disinfection; U.S. Pat. No. 5,053,140 describes an apparatus and a process for applying ozone to waste water to remove fats, solids and bacteria therein; and, U.S. Pat. No. 5,011,599 describes a process for decomposing the herbicide, atrazine, in waste water.

Ozone has also been used as a disinfectant/oxidant in the food industry for several decades. It is currently generally recognized as safe by the Food and Drug Administration and has been applied, e.g., to bulk storage (in a “room” type of storage facility) of produce, such as apples. Various gaseous ozone treatments to disinfect foodstuffs are known.

For example, in U.S. Pat. No. 5,431,939, a method is described for treating a shell egg using biocidally active gases including ozone. The process requires heating the egg to more than 129.9° F. At elevated temperatures, however, ozone is more unstable and easily decomposes.

U.S. Pat. No. 4,549,477 describes an ozone treatment apparatus for treating food using a conveyor means for continuous processing. However, such a process design renders it impossible to employ vacuum and/or pressure during gaseous ozone treatment.

U.S. Pat. No. 5,015,442 describes an apparatus for sterilizing and deodorizing air to remove odors from the air.

U.S. Pat. No. 5,213,759 describes a method of sterilizing microorganisms by using both ozone gas and ultraviolet radiation to obtain a synergistic effect.

U.S. Pat. No. 5,011,699 describes a process for sterilizing foodstuffs using mixtures of ozone gas, carbon dioxide and nitrogen using high concentrations of ozone, i.e., from 33.3% to 66.7% of ozone.

U.S. Pat. No. 5,281,428 describes a method and apparatus for treating and packaging raw meat by first exposing the meat to a vacuum, flushing the surface of the meat with an air-free treatment gas, and re-exposing the meat to vacuum.

U.S. Pat. No. 6,086,833 describes systems and processes for sanitizing a food product using ozone gas wherein a device for mixing ozone with a carrier fluid is used comprising a venturi nozzle having an outlet and two inlets for the ozone and carrier gas.

U.S. Pat. Nos. 6,066,348 and 6,294,211 describe a method of disinfecting a foodstuff using a gaseous mixture containing ozone in an amount and for a time sufficient to effect disinfection.

U.S. Pat. No. 6,171,625 further describes a system for the decontamination of agricultural products by reacting the toxins and microorganisms, contaminating the product, with ozone gas. The ozone is generated on site and upon demand, thus eliminating ozone waste associated with long periods of ozone storage. The system is said to provide efficient, safe, and environmentally friendly use of ozone for product decontamination by optimizing the delivery of ozone to the contaminated product, monitoring and controlling the pressure in the treatment systems, monitoring and controlling the heat generated during the treatment of contaminated product with ozone, and controlling ozone release into the atmosphere.

Disinfection processes have also been developed using an ozone solution (e.g. by bubbling or injecting ozone gas through water) to sanitize/disinfect food products. For example, U.S. Pat. No. 5,087,466 describes a process for treating animal flesh to remove color and odor wherein the flesh is mixed with water and this aqueous mixture is placed in contact with ozone.

U.S. Pat. No. 4,849,237 further describes a method for sanitizing poultry carcasses using aqueous ozone.

U.S. Pat. No. 5,227,184 also describes a method for sanitizing food products using aqueous ozone.

In U.S. Pat. No. 4,376,130, the ozonolysis of whole cardamon seeds using aqueous ozone is described.

Heating is an effective and popular way to kill unwanted microbes. Once penetrated by heat, the molecules in cells, including its reproductive material, DNA, are denatured. Enzymes can also be denatured by heat since the proteins that make up the enzymes are damaged. Such denatured enzymes cannot perform their normal metabolic roles.

While the use of ozone and heat treatment for sanitizing/disinfecting food is known, as described above, there are shortcomings with such methods. For example, as mentioned above, even though heat is an efficient means of killing bacteria, it also destroys some nutrients, flavors, or textural attributes of food products. Ozone treatment, as well, suffers from several disadvantages including its high reactivity and short half life in air of about 24 hours. Ozone decomposition is also accelerated by water, certain organic and inorganic chemicals, the use of higher temperatures and pressures, contact with surfaces, particularly organic surfaces, and by turbulence, ultrasound and UV light. As a consequence, unlike other gases, ozone is not generally suitable for storage for other than short periods of time.

The use of gaseous ozone for the treatment of foodstuffs also presents certain problems, including non-uniform distribution of ozone in certain foods or under certain storage conditions. As a result, the potential exists for overdosing in areas close to an ozone entry location, while those areas remote from the entry location may have limited exposure to an ozone containing gas.

A further important consideration in the use of ozone is the generally relatively high cost associated with ozone generation on a commercial scale, including the costs associated with waste recovery and the destruction of residual ozone.

In light of the foregoing problems associated with the use of ozone for the treatment of foodstuffs, a need exists for improvement in the sanitizing/disinfecting of foodstuffs while at the same time maintaining or improving the quality and enhancing the safety of such foodstuffs.

### OBJECTS AND SUMMARY OF THE INVENTION

It is an object of the present invention to provide a cooking process which demonstrates improved cooking efficiency of foodstuffs, improves the quality of such food and enhances the safety of food for consumption by mammals, especially humans.

In accordance with one aspect of the present invention, a method of improving the cooking efficiency of a foodstuff is provided, comprising sanitizing/disinfecting the foodstuff using an aqueous solution containing an effective amount of ozone, which comprises forming an aqueous solution of ozone, and contacting the foodstuff with the aqueous solution, and subsequently subjecting the foodstuff to a cooking process. The foodstuff is generally contacted with the aqueous solution for a time sufficient to substantially sanitize or disinfect the foodstuff. Optionally, the foodstuff may be packaged before or after the cooking process.

In order to improve the quality and enhance the safety of heat-treated foodstuffs, the present invention utilizes a process treatment of the foodstuff with an aqueous ozone solution combined with a cooking process to provide a synergistic effect on the killing rates of microorganisms as well as a reduction of the level of microorganisms on and in such foodstuffs.

It is known that many bacteria have the ability to repair themselves, especially if they are spore-formers. Spores are generally adaptive to even steam temperatures such that a single treatment may not be effective to kill or substantially reduce the level of microorganisms. If one treatment alone does not kill all microorganisms present, a subsequent step may have a better chance of being effective, as the cells generally get weaker and weaker with accumulated stress. The use of an aqueous ozone treatment process for foodstuffs, in conjunction with a cooking process according to the invention, provides a multi-technologies approach to reducing the level of microorganisms associated with foodstuffs which has advantages over the use of a single technology. The inventive process therefore allows food processors to reduce the amount of cooking needed, i.e., temperature and/or time of cooking, with a resulting enhancement in food quality and safety.

### BRIEF DESCRIPTION OF THE FIGURES

FIG. 1 schematically illustrates the improvement of cooking efficiency of a foodstuff (e.g. beef) according to one embodiment of the invention.

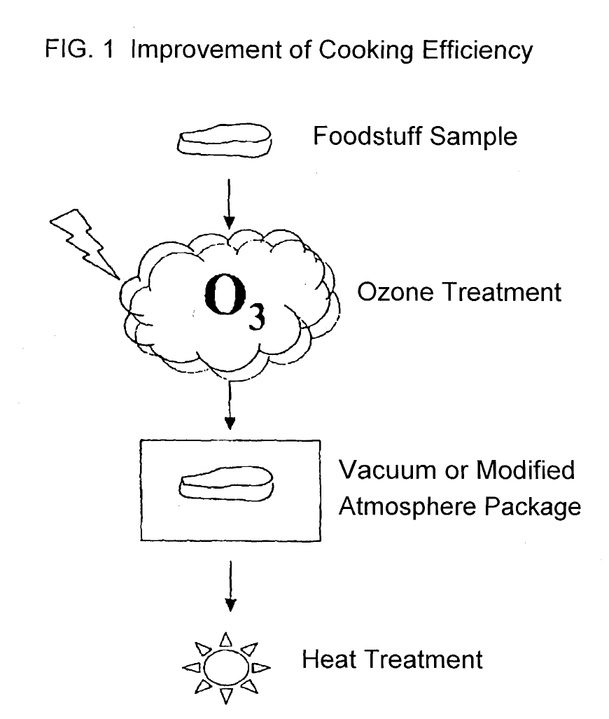

FIG. 2 depicts experimental results for the reduction of C. perfringens on beef surfaces exposed to 5 ppm of aqueous ozone for 5 minutes.

### DETAILED DESCRIPTION OF THE PREFERRED EMBODIMENTS OF THE INVENTION

In accordance with the present invention, a process is provided for improving the cooking efficiency of a foodstuff by disinfecting and/or sanitizing the foodstuff using an aqueous solution containing an effective amount of ozone in combination with a cooking process for the foodstuff. The ozone treatment may be used prior to, during all of or a portion of a process for treating the foodstuff, or thereafter, to eliminate or significantly reduce the content of microorganisms, bacteria or fungal spores, or viruses in or on the foodstuff.

As used herein, the term “foodstuff” generally refers to all types of foods, including, but not limited to, meats, including ground meats, poultry, seafood, produce including vegetables and fruit, dry pasta, breads and cereals and fried or baked snack foods. The present invention may be generally used in conjunction with any foodstuff that is able to support microbial, i.e. fungal, bacterial or viral growth, including unprocessed or processed foods, and food products. The foodstuff must generally be compatible for treatment with an aqueous solution containing ozone.

The terms “sanitize” and disinfect”, as well as variations thereof, generally mean the reduction of the microbial content of food. The terms substantially sanitize and “substantially disinfect” refer to the attainment of a level of microorganisms in the foodstuff such that the foodstuff is safe for consumption by a mammal, particularly by humans. Generally, as used herein, these terms refer to the elimination of at least about 90.0 to 99.9% of all microorganisms, including pathogenic microorganisms, in the treated foodstuff. Preferably, at least about 99.0 to 99.99%, and more preferably at least about 99.9 to 99.999% of such microorganisms, are eliminated.

The term “cooking efficiency”, as used in the context of the present invention, is associated with improving the quality of and enhancing the safety of heat-treated foodstuffs for consumption by mammals, particularly humans. More specifically, the “cooking efficiency” may be said to be synergistically improved when the content of microorganisms on or in such foodstuff, particularly those causing food-borne illnesses, is reduced compared with levels which would be expected for heat treatment and/or ozone treatment of the foodstuff alone.

In general, the process according to the invention provides an aqueous solution containing an effective amount of ozone. The aqueous solution containing ozone may be produced by introducing a gaseous stream or gaseous mixture containing ozone into water or an aqueous solution. The gaseous stream or mixture generally comprises from about 1 ppm to about 15% by weight of ozone. Although in principle not limited to a specific range of ozone content, the aqueous solution containing ozone typically has a dissolved ozone content of from about 0.1 ppm to about 30 ppm, preferably from about 1 to about 8 ppm of ozone, and most preferably from about 1 to about 6 ppm of ozone.

The gaseous stream or mixture containing ozone may be generated by feeding oxygen, air or a mixture of oxygen and air to an ozone generator prior to the preparation of the aqueous solution containing ozone and the treatment of the foodstuff. The gaseous stream or mixture containing ozone may also be produced from a feed gas containing oxygen, air, a mixture of oxygen and air or a mixture of oxygen, air and an inert gas such as, e.g., nitrogen, carbon dioxide, argon, krypton, xenon, neon or mixtures thereof.

The foodstuff is generally contacted with the aqueous solution containing ozone in a temperature range of from about −20° C. to about 150° C., preferably from about 0° C. to about 25° C., and more preferably from about 4° C. to about 10° C. The use of solutes or solutions, or pressure conditions, is also possible to form an aqueous solution at the contacting temperature.

The foodstuff is intended to be contacted with the aqueous solution containing ozone for a time sufficient to substantially sanitize or disinfect the foodstuff. While the time periods necessary to achieve this condition will vary depending on the particular foodstuff, and the amount of cooking the foodstuff is subjected to, in general, the time period ranges from about 1 second to about 1 hour, preferably from about 15 seconds to about 15 minutes.

The foodstuff may be subjected to a batch treatment with the aqueous solution containing ozone (e.g. about 3 to about 8 ppm for 5 minutes) or may be contacted with the solution in a continuous process. A suitable ozone concentration for use in such a continuous process is about 5 ppm for a exposure period of about 5-10 minutes. Other ozone concentrations and exposure periods noted previously may also be used, however.

Generally, inert gas or inert gases may be applied along with gaseous ozone in the process of the present invention. As used herein, the term “inert gas” refers to any non-oxidative or non-reactive gas and includes gases such as nitrogen, carbon dioxide, argon, krypton, xenon and neon or any mixture thereof.

Generally, the cooking process utilized in the present invention is a heat treatment process, such as in an oven or other closed or controlled environment. Other heat treatment cooking processes, such as grilling (e.g. in the case of meats and other suitable foods), boiling, or frying, may be utilized without limitation. The cooking process may, e.g., include other known cooking steps or processes, such as, e.g., microwave treatment, or convective or radiative heating. The use of heated gases, including steam, is also possible, and may be preferred for certain foodstuffs.

In a preferred embodiment, the cooking process comprises heat treatment of the foodstuff at a temperature in the range of from about 25° C. to about 150° C., preferably from about 45° C. to about 80° C., for a time period of from about 1 second to about 72 hours, preferably from about 5 minutes to about 60 minutes. The cooking process may also be conducted at atmospheric pressure, under vacuum, or at a pressure up to about 300,000 psi. A gaseous atmosphere comprising, e.g., air, oxygen, carbon dioxide, carbon monoxide, nitrogen, argon, or mixtures thereof, may also be utilized during the cooking process.

The process of the invention may optionally include packaging of the foodstuff comprising placing the foodstuff in a container and sealing the container. A vacuum may be optionally applied to the container to remove air or other gas from the container. A purge gas may be further optionally injected into the container, either with or without the use of a vacuum step. The purge gas may be applied before, after or both before and after the use of a vacuum step. The purge gas may be, e.g., nitrogen, carbon dioxide, carbon monoxide, argon, krypton, xenon, neon or a mixture thereof.

In a preferred embodiment, the foodstuff is treated with the aqueous solution containing ozone, is placed in a container, a vacuum is applied to the container to remove air or other gas from the container, and the container is sealed to maintain the vacuum in the container.

The optional container used to contain the foodstuff is not particularly limited and includes, e.g., disposable and reusable containers of all forms, including those which may be microwavable and/or oven-proof.

The present invention may be advantageously used to destroy viruses, bacteria and/or fungi. Preferably, the microorganisms destroyed are those causing food-borne illnesses. As used herein, the term “food-borne” illness means any single or combination of illnesses caused by microorganisms in mammals consuming foods containing those microorganisms.

Examples of bacteria causing such illnesses are various species of Salmonella, Staphylococcus, Streptococcus and Clostridium. For example, Escherichia coli, including E. coli 0157:H7, Salmonella typhimurium, Salmonella Schottmulleri, Salmonella choleraesuis, Salmonella enteritidis, Staphylococcus aureus, Streptococcus faecalis, Clostridium botulinum and Clostridium perfringens may be noted. Generally, the present invention may be advantageously used against any bacteria which produce a toxin or an enzyme or both, e.g., as a mechanism of pathogenicity.

For example, hyaluronidase, an enzyme that digests the intracellular cement, hyaluronic acid, is produced by some pathogenic strains of Staphylococci, Streptococci and Clostridia.

As examples of toxins, the neurotoxin of Clostridium botulinum and the enterotoxin produced by Staphylococcus aureus may be noted.

An example of fungi causing mycotoxicosis, a collective term for diseases induced by consumption of food made toxic by the growth of various fungi, are Aspergillus flavus in peanuts, peanut butter, rice, cereal grains and beans, for example, to produce any one of the many known aflatoxins. Another example is Aspergillus ochraceus, which may grow in corn, grain, peanuts, Brazil nuts, and cottonseed meal, for example, to produce the toxins, ochratotoxin A and B. Yet another example is a mycotoxin released by Penicillium toxicarium growing on rice which causes paralysis, blindness and death in experimental animals. Still another example is Fusarium graminearum.

Having described the present invention, reference will now be made to certain examples provided solely for the purposes of illustration. These examples are not to be interpreted as limiting the scope of the invention.

### EXAMPLES

In order to illustrate the effectiveness of the inventive process, a meat sample (London Broil Beef) was purchased from a local supermarket for testing. The meat sample was cut into 3×4×0.5 in. sections (100-150 g) prior to treatment and sterilized by irradiation to eliminate contaminating microorganisms using a self-contained ¹³⁷Cs gamma-radiation source (available at the USDA Eastern Regional Research Center facility, 42 kGy/−30° C.). All samples were inoculated by dipping into a stationary phase culture that was prepared from a mixture of disease producing strains (H6, E13, F5603) of C. perfringens. The control was dip inoculated for 30 sec. followed by dilution with 10 ml peptone water, stomaching 2 minutes on high setting (by placing samples in sterile filter bags, hand massaging for 30 seconds followed by 2 minutes of pummeling using a Stomacher lab-blender, model 400 from Spiral Systems, Inc., Cincinnati, Ohio), dispensing into vacuum-sealed bags, immersion at 60° C. for 0, 10, 20, and 30 minutes, and tempering on ice. This was followed by serial dilutions of the sample surface wash effluents with peptone water, and spread plating onto a rich medium. The plates were then incubated under anaerobic conditions for viable bacterial count tabulations. The heat-treated sample was exposed to 55° C. for 30 minutes prior to dilution, stomaching (as described above), 60° C. treatment of the filtrate from the stomaching bag, and plating over time. The ozone treated sample was exposed to 3.0 ppm to 5.0 ppm dissolved ozone at approximately 4-8° C. for 5 minutes, followed by dilution, stomaching (as described above), 60° C. treatment of the filtrate from the stomaching bag, and plating over time.

An ozone system designed to ozonate a reservoir of water at about 4° C. to ozone levels of 3 ppm to 5 ppm was used to prepare the ozone solutions for treatment of the samples. The ozone generation system included an ozone generator (Ozonia discharge generator), a feed supply of oxygen, an ozone monitor and probe, a reserve water tank and pump for circulating the ozonated water, an ozone destruction column for the treatment of ozone off-gassing, and a stainless steel treatment vessel for gentle agitation of samples treated with the ozone solution.

Heat treated samples were vacuum sealed in bags (to 20 mbar) and then heated at the temperatures noted above for approximately 30 minutes in temperature controlled water baths to simulate cooking conditions.

The heat-treated sample showed that any survivors were more heat resistant under these conditions than the control, whereas the ozone-treated sample survivors were less resistant than the control under the same conditions. Therefore, this provides evidence that although initial plating on rich media show insignificant differences between treatments for pathogen survivor numbers the differences were really quite significant when examined for injury adaptations that may affect the true potential for further growth. The ozone treatment is much better long term than expected from initial survivor counts. In other words, the C. perfringens cocktail inoculated on the beef that survived ozone treatment was far more susceptible to later following heat treatments than controls in which no ozone treatment was performed or survivors that survived only heat treatment and became more resistant.

The foregoing results demonstrate that ozone treatment performs best since any of the survivors remaining on the meat are more weakened than survivors from other treatments, especially heat. More importantly, the results summarized in Table 1, demonstrate that the combination of ozone treatment and heat treatment provides a synergistic effect compared against the control samples or heat treatment alone. Specifically, the bacterial count for the combined ozone and heat treatment samples is significantly less than would be expected for such samples based upon the results for the control samples or the samples treated only with heat.

TABLE 1
Populations of C. perfringens enumerated from the
surface of beef samples (CFU/mL)

| Treatment | Control + | Heat Treated + | Ozone + |
|---|---|---|---|
| Time (min) | Heat Treated | Heat Treated | Heat Treated |
| 0 | 7.13 | 7.02 | 6.18 |
| 10 | 5.85 | 6.59 | 3.30 |
| 20 | 1.70 | 5.78 | 0 |
| 30 | 0 | 5.32 | 0 |

In order to illustrate the separate and combined effects of ozone and heat treatment, a study was also performed on beef samples exposed to aqueous ozone treatment, heat treatment, or a combination of ozone and heat treatments. All samples were prepared, irradiated and innoculated with strains of C. perfringens, as described above. Ozone treated samples were exposed to 5 ppm aqueous ozone at approximately 4-8° C. for 5 minutes. Heat treated samples were vacuum sealed in bags (to 20 mbar) and then heated at temperatures of 45° C. 55° C. or 65° C. for approximately 30 minutes in temperature controlled water baths to simulate cooking conditions. The control sample received no ozone or heat treatment following preparation, irradiation and innoculation.

The results summarized in Table 2, demonstrate that the combination of ozone treatment and heat treatment provides a synergistic effect compared against the control, and the samples which were separately treated with ozone or received heat treatment alone.

TABLE 2
Reductions in C. perfringens populations enumerated from
the surface of beef samples (CFU/g)

| | Ozone | | |
|---|---|---|---|
| | Treatment | Heat Treatment | Log₁₀ (CFU/g) |
| Sample | (min.) | Temperature | Reductions |
| control | 0 | none | 0.0 |
| 1 | 5.0 | none | 1.509 |
| 2 | 0 | 45° C. | 0.078 |
| 3 | 5.0 | 45° C. | 2.080 |
| 4 | 0 | 55° C. | 1.088 |
| 5 | 5.0 | 55° C. | 2.891 |
| 6 | 0 | 65° C. | 5.665 |
| 7 | 5.0 | 65° C. | 5.665 |

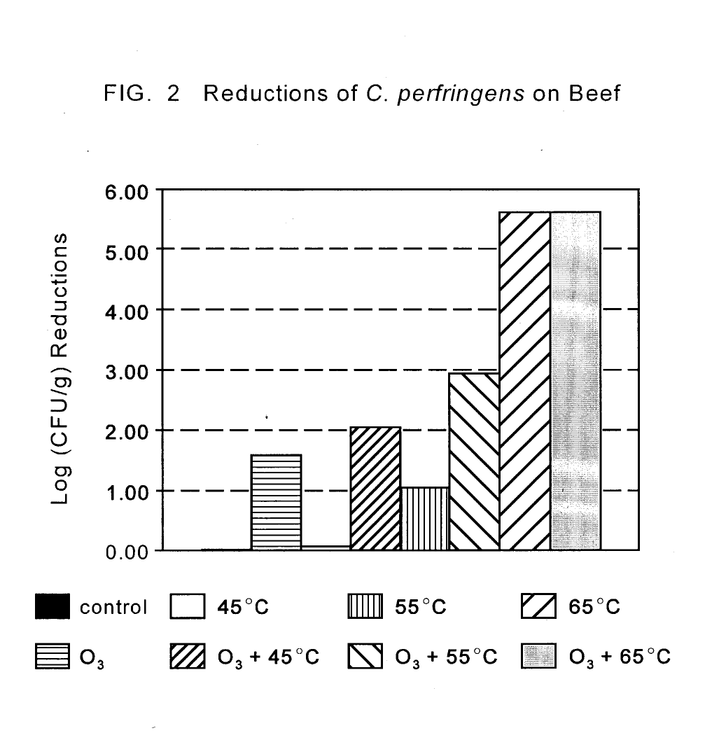

FIG. 2 graphically summarizes the above results for the reduction of C. perfringens populations on the surfaces of these beef samples.

While the invention has been described in detail by reference to specific embodiments, the skilled artisan will appreciate that various modifications, substitutions, omissions and changes may be made, and equivalents employed, without departing from the spirit of the invention or the scope of the appended claims.

What is claimed is:

1. A method of improving the cooking efficiency of a foodstuff comprising
sanitizing/disinfecting the foodstuff using an aqueous solution containing an effective amount of ozone, which comprises
forming an aqueous solution of ozone, and
contacting the foodstuff with the aqueous solution,
wherein said foodstuff is contacted with said aqueous solution at a temperature and for a time sufficient to substantially sanitize the foodstuff;
optionally, packaging the foodstuff; and
subjecting the foodstuff to a cooking process.

2. The method of claim 1, wherein the cooking efficiency of said foodstuff is synergistically improved as compared with ozone treatment alone and/or heat treatment alone of said foodstuff.

3. The method of claim 1, wherein said aqueous solution containing ozone is produced by introducing a gaseous stream or gaseous mixture containing ozone into water or an aqueous solution.

4. The method of claim 3, wherein said gaseous stream or mixture comprises from about 1 ppm to about 15% by weight of ozone.

5. The method of claim 1, wherein said aqueous solution containing ozone is contacted with the foodstuff at a temperature of about −20° C. to about 150° C.

6. The method of claim 1, wherein said aqueous solution containing ozone is contacted with the foodstuff at a temperature of about 0° C. to about 25° C.

7. The method of claim 6, wherein said aqueous solution containing ozone is contacted with the foodstuff at a temperature of about 4° C. to about 10° C.

8. The method of claim 3, wherein said aqueous solution containing ozone has a dissolved ozone content of from about 0.1 ppm to about 30 ppm.

9. The method of claim 8, wherein said aqueous solution has a dissolved ozone content of from about 1 ppm to about 10 ppm.

10. The method of claim 8, wherein said aqueous solution has a dissolved ozone content of from about 1 ppm to about 6 ppm.

11. The method of claim 1, wherein said cooking process comprises heat treatment of said foodstuff at a temperature in the range of from about 25° C. to about 150° C. for a time period of from about 1 second to about 72 hours.

12. The method of claim 11, wherein said cooking process comprises heat treatment of said foodstuff at a temperature in the range of from about 45° C. to about 80° C. for a time period of from about 5 minutes to about 60 minutes.

13. The method of claim 11, wherein said cooking process comprises heat treatment of said foodstuff at atmospheric pressure, under vacuum, or at a pressure up to about 300,000 psi.

14. The method of claim 11, wherein said heat treatment is conducted in a gaseous atmosphere comprising air, oxygen, carbon dioxide, carbon monoxide, nitrogen, argon, or mixtures thereof.

15. The method of claim 1, wherein said packaging of the foodstuff comprises placing said foodstuff in a container, optionally applying a vacuum to the container to remove air from the container, optionally injecting purge gas into the container, and sealing the container.

16. The method of claim 15, wherein said foodstuff is placed in a container, a vacuum is applied to the container to remove air or gas from the container, and the container is sealed to maintain the vacuum in the container.

17. The method of claim 15, wherein said purge gas is selected from the group consisting of nitrogen, carbon dioxide, carbon monoxide, argon, krypton, xenon, neon and mixtures thereof.

18. The method of claim 1, wherein said foodstuff is subjected to a batch or continuous treatment with said aqueous solution containing ozone.

19. The method of claim 16, wherein said aqueous solution in said batch or continuous treatment comprises from about 0.1 ppm to about 30 ppm of ozone, and is contacted with said foodstuff for a period of from about 1 second to about 1 hour.

20. The method of claim 19, wherein said aqueous solution comprises from about 1 ppm to about 10 ppm of ozone.

21. The method of claim 19, wherein said aqueous solution comprises from about 1 ppm to about 6 ppm of ozone.

22. The method of claim 19, wherein said aqueous solution in said batch or continuous treatment is contacted with said foodstuff for a period of from about 15 seconds to about 15 minutes.

23. The method of claim 3, wherein said gaseous stream or mixture containing ozone is generated by feeding oxygen, air or a mixture of oxygen and air to an ozone generator prior to treating said foodstuff.

24. The method of claim 3, wherein said gaseous stream or mixture containing ozone is produced from a feed gas containing oxygen, air, a mixture of oxygen and air or a mixture of oxygen, air and an inert gas selected from the group consisting of nitrogen, carbon dioxide, argon, krypton, xenon, neon and mixtures thereof.

25. The method of claim 1, wherein said foodstuff is selected from the group consisting of meat, poultry, seafood, grains, bread, cereal, pasta, fruit, vegetables and snack products.

26. The method of claim 1, wherein said foodstuff is sanitized/disinfected for bacteria causing food-borne illness in a mammal.

27. The method of claim 26, wherein said bacteria is selected from the group consisting of bacteria producing a toxin, an enzyme or both, as a mechanism of pathogenicity.

28. The method of claim 26, wherein said bacteria is selected from the group consisting of Staphylococcus aureus, Streptococcus facialis, Clostridium botulinum, Clostridium perfringeus and Escherichia coli 0157:H7.
